(19) United States
(12) Patent Application Publication
(10) Pub. No.: US 2005/0113153 A1
(43) Pub. Date: May 26, 2005

(54) Flip mobile phone

(76) Inventors: Pei-Wen Hung, Taichung City (TW); Jen-Cheng Lai, Taoyuan City (TW); Yu-Chuan Chang, Jhonghe City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/983,779

(22) Filed: Nov. 8, 2004

(30) Foreign Application Priority Data
Nov. 25, 2003 (TW) 92133103

(51) Int. Cl. H04M 1/00

(52) U.S. Cl. 455/575.3; 455/575.1

(57) ABSTRACT

A flip mobile phone includes a main body, a cover and a conducting device having a turning portion. The main body has a first pivot portion, and the cover has a second pivot portion. The second pivot portion is coupled with the first pivot portion so that the cover is able to rotate with respect to the main body. In the interior of the first pivot portion and the second pivot portion, there is a hollow portion used for receiving the conducting device which electrically connects the main body and the cover. The conducting device has a transiting component which is equipped on the turning portion, and has a first wire end and a second wire end which is connected to the main body and the cover respectively. The first wire end and the second wire end are electrically connected to the transiting component respectively.

This application claims the benefit of Taiwan application Serial No. 92133103, filed Nov. 25, 2003, the subject matter of which is incorporated herein by reference.

### BACKGROUND OF THE INVENTION

1. Field of the Invention

The invention relates in general to a mobile phone, and more particularly to a flip mobile phone.

2. Description of the Related Art

Most of the consumptive electronic products with the cover; such as the notebook computer, digital camera, and mobile phone, use the flexible printed circuit board to electrically connect the cover and the main body. The flexible printed circuit board is the medium of transmitting signals between the cover and the main body. Transmitting signals means delivering any kind of the message, such as the sign, word, picture, and voice. If the wire is used to deliver the message, the stability of the wire can be the most important thing that can influence the quality of the transmission.

FIG. 1 shows a traditional flip mobile phone. The traditional flip mobile phone 10 has a main body 101, a cover 103, and a signal-transmitting part, such as the flexible printed circuit board 105. FIG. 1 shows a traditional flip mobile phone with the cover 103 taken away from the main body 101.

The main body 101 has the first pivot portion 1010, and the cover 103 has the second pivot portion 1030. The second pivot portion 1030 is coupled with the first pivot portion 1010 so that the cover 103 is able to rotate with respect to the main body 101.

Regarding to the cover 103 and the main body 101 in FIG. 1, there is a hollow portion for receiving the flexible printed circuit board 105. The hollow portion is formed in the interior of the first pivot portion 1010 and the second pivot portion 1030.

The flexible printed circuit board 105 is inside the main body 101 and the cover 103 which can rotate with respect to each other. The flexible printed circuit board 105 electrically connects the main body 101 and the cover 103. Moreover, the flexible printed circuit board 105 is the medium of transmitting the signal between the cover 103 and the main body 101.

FIG. 2 shows the disposition of the flexible printed circuit board in the flip mobile phone. The flexible printed circuit board 105 connects to the main body 101 and the cover 103 by the connecting part 1052a and 1052b. As shown in FIG. 2, because of the shape of the first pivot portion 1010 and the second pivot portion 1030, the flexible printed circuit board 105 has to have a winding turning portion 1050 to connect the main body 101 and the cover 103.

The cover 103 rotates with respect to the main body 101 in the process of opening or closing the cover 103 repeatedly so that the flexible printed circuit board 105 is also twisted again and again. Therefore, the turning portion 1050 of the flexible printed circuit board 105 is easy to be damaged by the fatigue. As a result, the signal-transmitting deteriorates from fatigue. Further, the turning portion 1050, a part of the flexible printed circuit board 105 which is easily stressed and damaged, is liable to have the crack that caused by the fatigue. In case of this, in order to remove the flexible printed circuit board 105 from the flip mobile phone for repairing, one has to disassemble the main body 101 and the cover 103. However, disassembling and assembling the main body 101 and the cover 103 take a lot of time.

### SUMMARY OF THE INVENTION

It is therefore an object of the invention to provide a flip mobile phone having a conducting device which is used to electrically connect the main body and the cover so as to prevent from being damaged of fatigue by opening or closing the cover repeatedly. Besides, the conducting device is removed for repairing easily.

The invention achieves the above-identified object by providing a flip mobile phone. The flip mobile phone has a main body, a cover, and a conducting device with a turning portion. The main body has a first pivot portion, and the cover has a second pivot portion. The second pivot portion is pivotally coupled with the first pivot portion so that the cover is rotatable with respect to the main body. A hollow portion is formed in the interior of the first pivot portion and the second pivot portion. The second pivot portion has a cap which is easy to be taken apart from or put on the second pivot. Besides, the hollow portion is exposed after taking the cap apart from the second pivot. The conducting device, received in the hollow portion, is used to electrically connect to the main body and the cover. The conducting device also has a transiting component which is disposed on the turning portion. Moreover, the conducting device has a first wire end and a second wire end which are connected to the main body and the cover respectively. The transiting component electrically connects the first wire end and the second end.

A connector can be disposed on the transiting component, so the first wire end or the second wire end can be connected to the transiting component by the connector. The connector can be a pin type or zebra type connector. The transiting component can be a printed circuit board or a flexible printed circuit board. The first wire end and the second wire end are disposed in the main body and the cover respectively.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) shows a traditional flip mobile phone.

FIG. 2 (Prior Art) shows the disposition of the flexible printed circuit board in the flip mobile phone.

FIG. 3A is a view of the flip mobile phone according to the preferred embodiment of the invention.

FIG. 3B shows the flip mobile phone of FIG. 3A, wherein the cap is taken apart from the flip mobile phone to expose the conducting device.

FIG. 4 is a partially enlarged view of FIG. 3B.

FIG. 5A shows the transiting component of the conducting device having a pin type connector.

FIG. 5B shows the transiting component of the conducting device having a zebra type connector.

### DETAILED DESCRIPTION OF THE INVENTION

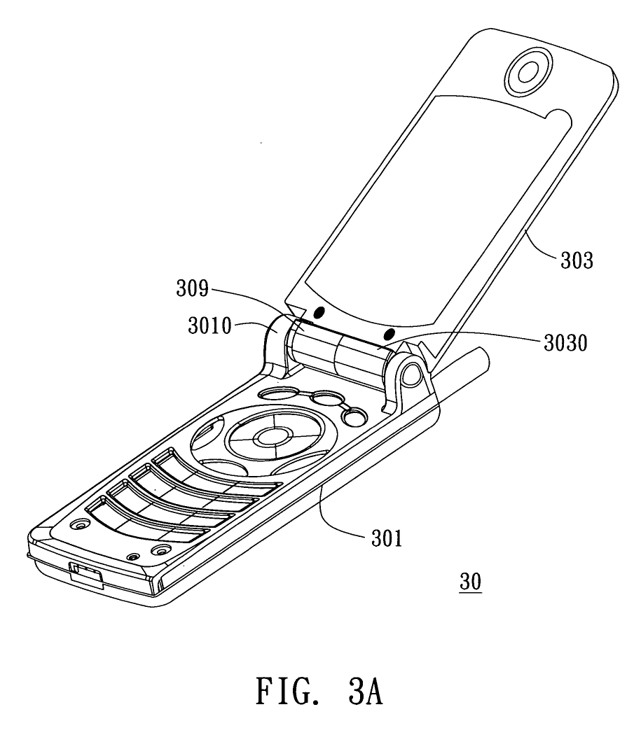

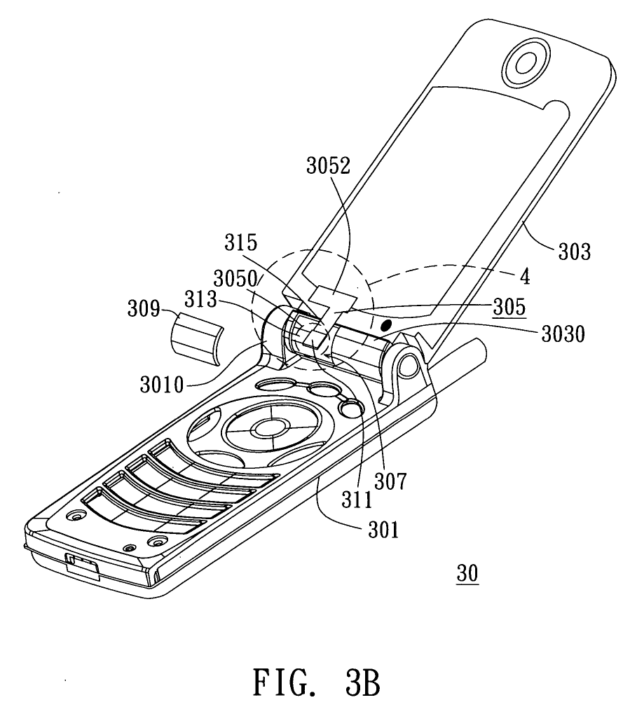

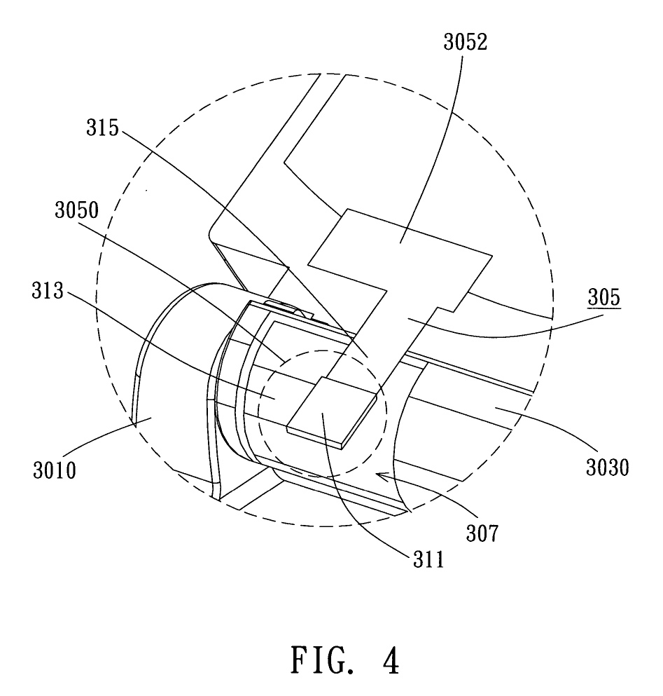

Referring to FIG. 3A, FIG. 3B, and FIG. 4. FIG. 3A is a view of the flip mobile phone according to the preferred embodiment of the invention. FIG. 3B shows a flip mobile phone of FIG. 3A. The cover in FIG. 3B is taken apart from the flip mobile phone to expose the conducting device. FIG. 4 is a partially enlarged view of FIG. 3B. The flip mobile phone 30 includes a main body 301, a cover 303, and a conducting device 305 having a turning portion 3050.

The main body 301 has the first pivot portion 3010, and the cover 303 has the second pivot portion 3030. The second pivot portion 3030 is coupled with the first pivot portion 3010 so that the cover 303 is able to rotate with respect to the main body 301.

There is a hollow portion 307 in the interior of the first pivot portion 3010 and the second pivot portion 3030. The second pivot portion 1030 has a cap 309 which is easy to be taken apart from or put on the second pivot portion. After taking the cap 309 apart from the second pivot portion 3030, the hollow portion 307 is exposed.

The conducting device 305 is received in the hollow portion 307, which is formed inside the main body 301 and the cover 303. The conducting device 305 is also the medium of transmitting the signal between the cover 303 and the main body 301. Moreover, the conducting device 305 electrically connects the main body 301 and the cover 303.

The conducting device 305 connects the cover 303 by the connecting part 3052, and the other connecting part of the connecting device 305 is disposed inside and connected to the main body 301. Referring to FIG. 3B and FIG. 4, because of the shape of the first pivot portion 3010 and the second pivot portion 3030, the conducting device 305 has to have a turning portion 3050 to connect the main body 301 and the cover 303. Whenever the cover 303 rotates with respect to the main body 301 in the process of opening or closing the cover 303, the conducting device 305 is twisted.

The conducting device 305 according to the preferred embodiment of the invention is disposed in the hollow portion 307 of the flip mobile phone and has a transiting component 311. The transiting component 311 is disposed on the turning portion 3050. The conducting device 305 further has the first wire end 313 and the second wire end 315 which are connected to the main body 301 and the cover 303 respectively. Moreover, the first wire end 313 and the second wire end 315 connect to the transiting component 311 respectively.

The first wire end 313 and the second wire end 315 as stated above can be the end of a flexible circuit board, and the transiting component 311 can be a printed circuit board or a flexible circuit board with high strength.

A special design of the invention is separating the turning portion 3050 of the conducting device 305 into two parts, preventing from being damaged or deformed of the turning portion 3050 after daily operation of the flip mobile phone 30.

Besides, the cap 309, disposed on the second pivot portion 3030, is easy to be taken apart from and put on the second pivot 3030. Putting the cap 309 on the second pivot portion 3030 hides the hollow portion 307, and makes the appearance of the flip mobile phone look smooth.

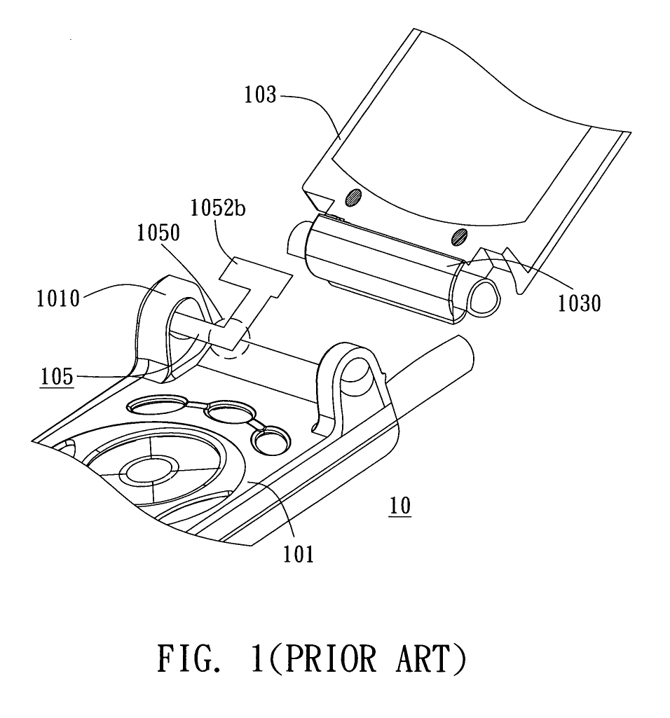

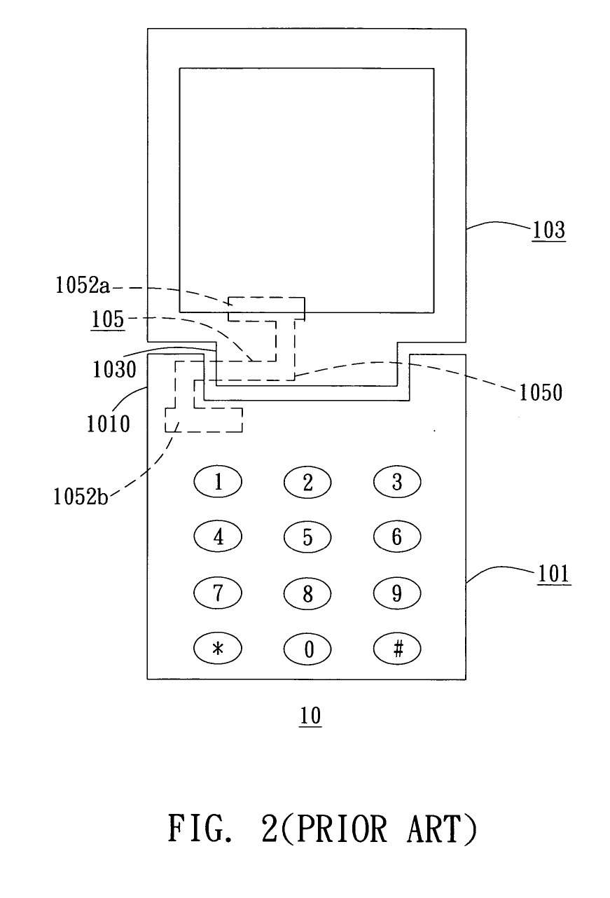

When the conducting device 305, disposed inside the flip mobile phone 30, malfunctions, such as the conducting device 305 is broken or the flip mobile phone 30 is failure to use, one can easily take the cap 309 apart from the second pivot portion 3030 to check, change, or repair the conducting device 305. After solving the problem of the conducting device, the cap 309 is easily put back on the second pivot portion 3030. The cap 309 of the flip mobile phone is easily taken apart from and put back on the second pivot portion 3030. Therefore, unlike the traditional flip mobile phone in FIG. 1, the user no longer has to disassemble the cover 103 and the main body 101, which are difficult to be disassembled, in order to check or repair the flexible printed circuit board 105 of the flip mobile phone.

The following is another advantage of the flip mobile phone 30. When the conducting device 305 is broken, one can just take the cap 309 apart from the second pivot portion for repair instead of changing the whole conducting device.

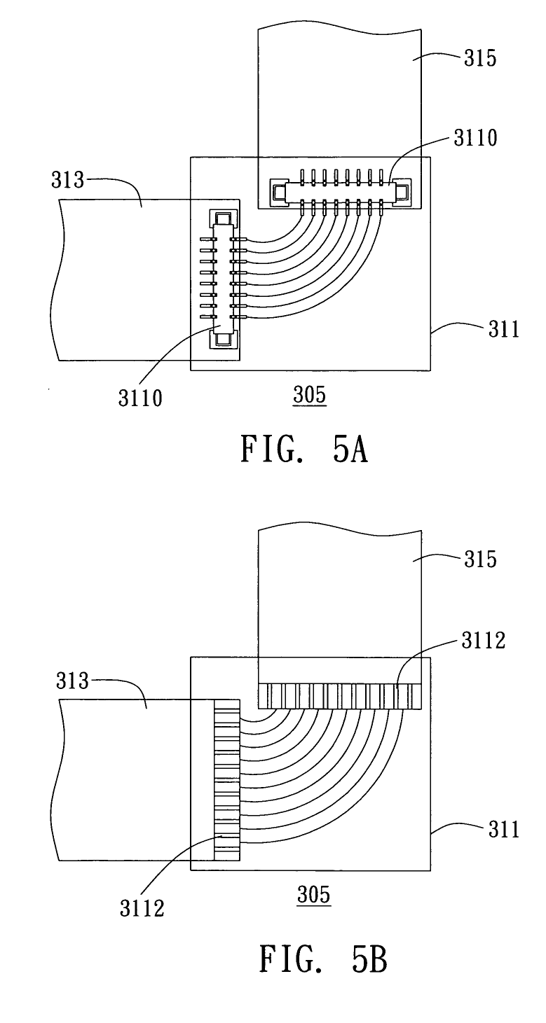

FIG. 5A shows the transiting component of the conducting device having the pin type connector. The connector, such as the pin type connector 3110, can be disposed on the transiting component 311 of the conducting device 305. The first wire end 313 and the second wire end 315 can be electrically connected to the transiting component 311 by the pin type connector 3110.

The transiting component 311 can receive and deliver the electronic signal. By using the pin type connector 3110, the transiting component 311 can be connected to the first wire end 313 and the second wire end 315. The advantage of using the pin type connector 3110 is the removable insertion of the first wire end 313 and the second wire end 315, which electrically connect the pin type connector 3110.

FIG. 5B shows the transiting component of the conducting device having the zebra type connector. As stated above, besides the pin type connector 3110, the zebra type connector 3112 which has the same function as the pin type connector 3110 also can be disposed on the transiting component 311 of the conducting device 305. Any connector which electrically connects the first wire end and the second wire end by insertion is within the scope of the invention.

After assembling the main body 301 and the cover 303, one can use the pin type connector 3110 or the zebra type connector 3112 to connect the first wire end 313 and the second wire end 315 respectively. These connectors make the user to assemble the flip mobile phone easily.

The flip mobile phone according to the preferred embodiment of the invention has at least the following advantages. Because the conducting device is divided into two parts and the transiting component is disposed, the turning portion of the conducting device rarely has a fatigue damage which is caused by opening or closing the cover repeatedly. The cap, easily be taken away from or put on the second pivot portion, makes the conducting device which is disposed in the hollow portion easy to be checked and repaired. The disposition of the connector on the transiting component can make the transiting component to electrically connect the wire end by inserting the wire end into the connector. Besides, the user can take the cap apart from the second pivot portion for repair instead of changing the whole conducting device. In additon, the flip mobile phone of the invention can be assembled easily.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A flip mobile phone, comprising:
a main body having a first pivot portion;
a cover having a second pivot portion, the first pivot portion and the second pivot portion forming a hollow portion, the second pivot portion being pivotally coupled with the first pivot portion so that the cover is rotatable with respect to the main body; and
a conducting device with a turning portion, received in the hollow portion, for electrically connecting the main body and the cover, the conducting device including
a first wire end, connected to the main body,
a second wire end, connected to the cover, and
a transiting component, disposed at the turning portion, for electrically connecting the first wire end and the second wire end.

2. The flip mobile phone according to claim 1, wherein the transiting component includes a connector, for electrically connecting the first wire end and the transiting component or for electrically connecting the second wire end and the transiting component.

3. The flip mobile phone according to claim 2, wherein the first wire end or the second wire end is removably connected to the connector.

4. The flip mobile phone according to claim 2, wherein the connector is a pin type connector.

5. The flip mobile phone according to claim 2, wherein the connector is a zebra type connector.

6. The flip mobile phone according to claim 1, wherein the transiting component is a printed circuit board (PCB).

7. The flip mobile phone according to claim 1, wherein the transiting component is a flexible printed circuit board (FCB).

8. The flip mobile phone according to claim 7, wherein the flexible circuit board has the first wire end and the second wire end.

9. The flip mobile phone according to claim 1, wherein the flip mobile phone further comprises a cap which is easy to be taken apart from the second pivot, and the hollow portion is exposed after taking the cap apart from the second pivot.

10. A conducting device for electrically connecting a main body and a cover, wherein the conducting device comprises:
a first wire end, connected to the main body;
a second wire end, connected to the cover; and
a transiting component, disposed at a turning portion of the conducting device, for electrically connecting the first wire end and the second wire end.

11. The conducting device according to claim 10, wherein the transiting component includes a connector, for electrically connecting the first wire end and the transiting component or for electrically connecting the second wire end and the transiting component.

12. The conducting device according to claim 11, wherein the connector is a pin type connector.

13. The conducting device according to claim 11, wherein the connector is a zebra type connector.

14. The conducting device according to claim 10, wherein the connecting device is a flexible circuit board (FCB).
